(19) United States
(12) Patent Application Publication
(10) Pub. No.: US 2020/0166782 A1
(43) Pub. Date: May 28, 2020

(54) OPTICAL PHOTOGRAPHIC GLASSES

(71) Applicant: Tsai-Tzu LIAO, New Taipei City (TW)

(72) Inventor: Tsai-Tzu LIAO, New Taipei City (TW)

(21) Appl. No.: 16/200,732

(22) Filed: Nov. 27, 2018

(51) Int. Cl. G02C 11/00; G02C 7/02; G03B 15/02

(52) U.S. Cl. CPC G02C 11/10; G03B 15/02; G02C 7/02

(57) ABSTRACT

Described herein is a pair of optical photographic glasses which comprising one frame, two screens, and at least one light-emitting apparatus. Also provided herein is another pair of optical photographic glasses which comprising one frame, at least one camera lens, and a lot of light-emitting apparatuses. These two optical photographic glasses are equipped with a telecontroller or they are set with a storage device or a WI-FI wireless internet device or both in the electronic device. In this way, with the auxiliary light source provided by the light-emitting apparatus, images of the camera lens can be directly stored or transmitted by the video party or both.

### BACKGROUND OF THE INVENTION

### 1. Field of the Invention

The present invention relates to a spectacle, especially to one kind of optical photographic glasses which can utilize at least one light-emitting apparatuses to provide daytime and nighttime auxiliary light source and can directly store the images of camera lens in the storage device of the electronic device or directly transmitted by the video party through the WI-FI Wireless Internet device, or stored in the storage device and transmitted to computers by the WI-FI Wireless Internet device.

### 2. Description of Related Art

With regard to the conventional Google glasses, please refer to FIG. 8, the pictorial drawing of the Google Glasses. The structure of Google glasses is mainly that both sides of the frame 1 are equipped with the temple 1000, and one side of the temple 1000 of the frame 1 is equipped with the electronic device 10 containing a battery 101. The electronic device 10 is extended to one side of the front frame 1, its end portion is connected to a camera lens 11, and the electronic device 10 at the end portion of the temple 1000 is set a connection with the switch 100. As to the electronic device 10 which extends to the front of the frame 1 and contains the camera lens 11, it is set a screen 12. The screen 12 is extended to the other side of the front frame 1, set a bridge 13 comprising two nose pads 131 below, and connected to the other side of the temple 1000 of the frame 1. Since the conventional equipment itself doesn't provide any auxiliary light source, the camera lens 11 can not provide a clear picture to the screen 12 even unable to record any images in the daytime without sufficient light or nighttime. Furthermore, the conventional equipment can directly observe images merely through the screen 12, but it can not store the images, or utilize the WI-FI wireless internet, or chose to use one of the above two functions or both according to various user's needs. Therefore, the conventional equipment is restricted in the use of supplies. Moreover, the conventional equipment only can be operated by the switch 100 of the electronic device 10 located at the temple 1000, so that it can not be operated in the remote control mode, which causes the inconvenience of operation. In addition, the screen 12 is fixed at one side of the front frame 1, which is unable to provide the selective conversion of the lift up mode or the non-lift up mode depending on user's needs, so that hinders progressive improvement of the conventional equipment, which is the breakthrough for the industry and consumers eager to make. The present inventors took this point into consideration to progress the invention, and eventually accomplished a pair of optical photographic glasses which could provide auxiliary light source by at least one light-emitting apparatus, and could directly store images in the storage device of the electronic device, or directly transmit images by video party through the WI-FI Wireless Internet device, or store images in the storage device and transmit images to computers via the WI-FI Wireless Internet device. It's also according to the user's needs to lift up or turn down the lens or screens, and using the telecontroller as a wireless remote control. Regardless of during day or night, immediate image storage and transmission via the camera lens can effectively enhance its ease of use, and result in correspondence of novelty and improvement with the user's needs, which shows the gain of the invention.

### SUMMARY OF THE INVENTION

To solve the aforementioned deficiencies of the prior art, the main purpose of the present invention is to provide a pair of photographic optical glasses, which can utilize at least one auxiliary light source providing light to overcoming the difficulties of the prior art.

The present invention secondly aims to provide a pair of optical photographic glasses that can directly store images in the storage device of the electronic device, or directly transmit images by video party through the WI-FI Wireless Internet device, or store images in the storage device and transmit images to computers via the WI-FI Wireless Internet device.

Another object of the present invention is to provide a pair of optical photographic glasses, which can lift up or turn down the lens or screens according to the user's needs.

The further object of the present invention is to provide a pair of optical photographic glasses, which can utilize the telecontroller to connect with the electronic device for wireless remote control.

A further object of the present invention is to provide a pair of optical photographic glasses, which effectively enhance the convenience of its use.

The problems to be solved in the present invention are resulted from the conventional Google glasses. Its structure is mainly that both sides of the frame are equipped with temples, and one side of the temple of the frame is equipped with the electronic device containing a battery. The electronic device is extended to one side of the front frame, its end portion is connected to one camera lens, and the electronic device at the end portion of the temple is set a connection with a switch. As to the electronic device which extends to the front of the frame and contains a camera lens, it is set one screen. The screen is extended to the other side of the front frame, set a bridge comprising two nose pads below, and connected to the other side of the temple of the frame. Since the conventional equipment itself doesn't provide any auxiliary light source, the camera lens can not provide a clear picture to the screen even unable to record any images in the daytime without sufficient light or nighttime. Furthermore, the conventional equipment can directly observe images merely through the screen, but it can not store the images, or utilize the WI-FI wireless internet, or chose to use one of the above two functions or both according to various user's needs. Therefore, the conventional equipment is restricted in the use of supplies. Moreover, the conventional equipment only can be operated by the switch of the electronic device located at the temple, so that it can not be operated in the remote control mode, which causes the inconvenience of operation. In addition, the screen is fixed at one side of the front frame, which is unable to provide the selective conversion of the lift up mode or the non-lift up mode depending on user's needs, so that hinders progressive improvement of the conventional equipment.

In order to achieve the above objects, the present invention provides a pair of optical photographic glasses. The pair of optical photographic glasses includes:

one frame, which is equipped with temples on its both sides, lenses in the front of the frame, and an electronic device with a battery at least one side of the temple of the frame. The electronic device at the end portion of the temple connects with one switch and a bridge with two nose pads below is set in front of the frame;

at least one camera lens, which is provided on the bridge and connected with an electronic device;

two screens, which are located nearby the front of the frame and connected with the electronic device containing a camera lens;

at least one light-emitting apparatus, which is set in the frame.

Furthermore, a mobile component is appended between the lens and the frame of the present invention and it can turn down or lift up the lens.

Preferably, the light-emitting apparatuses of the present invention are set in front of the frame, or on the bridge which is in front of the frame, or around the lens which is in front of the frame, or around the frame and lenses.

Preferably, the light-emitting apparatuses of the present invention are visible light emitting diodes (LED) or invisible light emitting diodes (LED).

Furthermore, the electronic device of the present invention has at least one storage device, or at least one WI-FI wireless internet device, or at least one storage device and at least one WI-FI wireless internet device.

Furthermore, the present pair of optical photographic glasses further includes at least one telecontroller connected with the electronic device.

In order to achieve the above objects, the present invention provides another pair of optical photographic glasses. The pair of glasses includes:

one frame, which is equipped with temples on its both sides, an electronic device with a switch and a battery at least one side of the temple, and a bridge with two nose pads in front of the frame;

at least one camera lens which is provided on the front of the bridge and connected with an electronic device;

at least one screen, which is set under the bridge of the frame. A mobile component is set between the screen and the frame to life up or turn down the screen which is connected with the electronic device;

a lot of light-emitting apparatuses which are set in front of the screen.

Preferably, the light-emitting apparatuses of the present invention are visible light emitting diodes (LED) or invisible light emitting diodes (LED).

Furthermore, the electronic device of the present invention has at least one storage device, or at least one WI-FI wireless internet device, or at least one storage device and at least one WI-FI wireless internet device which are connected to each other.

Furthermore, the present pair of optical photographic glasses further includes at least one telecontroller connected with the electronic device.

In this way, the pair of optical photographic glasses provides auxiliary light source by at least one light-emitting apparatus, and can directly store images in the storage device of the electronic device, or directly transmit images by video party through the WI-FI Wireless Internet device, or store images in the storage device and transmit images to computers via the WI-FI Wireless Internet device. It's also according to the user's needs to lift up or turn down the lens or screens, and using the telecontroller as a wireless remote control. Regardless of during day or night, immediate image storage and transmission via the camera lens can effectively enhance its ease of use, and result in correspondence of novelty and improvement with the user's needs, which shows the gain of the invention.

### BRIEF DESCRIPTION OF THE DRAWINGS

FIG. 1 is a three-dimensional breakdown drawing of the present invention;

FIG. 2A is a three-dimensional assembly drawing of the present invention;

FIG. 2B is a pictorial drawing of the present invention which the lenses are lifted up;

FIG. 2C is a pictorial drawing of the present invention which the light-emitting apparatuses are set in front of the frame;

FIG. 2D is a pictorial drawing of the present invention which the light-emitting apparatuses are set around the frame;

FIG. 2E is a pictorial drawing of the present invention which the light-emitting apparatuses are set around the frame and lenses;

FIG. 2F is a diagrammatic drawing of the present invention which the light-emitting apparatuses are attached outside of the frame;

FIG. 3 is an assembly profile drawing of the present invention;

FIG. 4 is a three-dimensional breakdown drawing of another embodiment in the present invention;

FIG. 5 is a three-dimensional assembly drawing of another embodiment in the present invention;

FIG. 6 is an assembly profile drawing of another embodiment in the present invention;

FIG. 7 is a diagrammatic drawing of another embodiment in the present invention which the screen comprising light-emitting apparatuses are lift up; and

FIG. 8 is a pictorial drawing of the Google glasses.

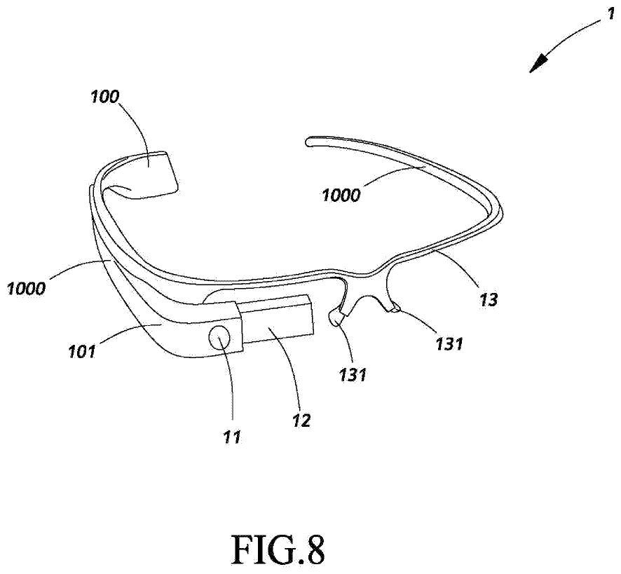

### DETAILED DESCRIPTION OF THE PREFERRED EMBODIMENT

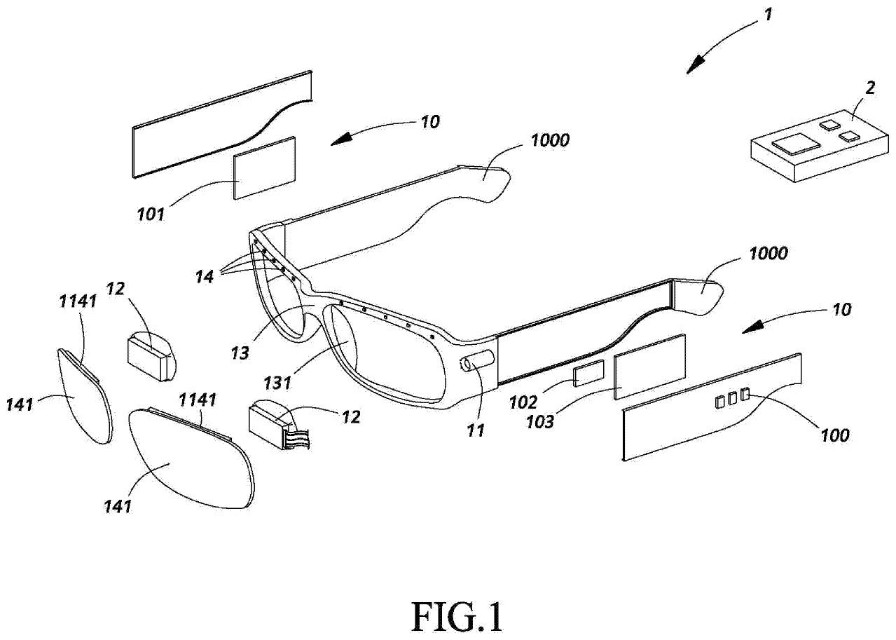

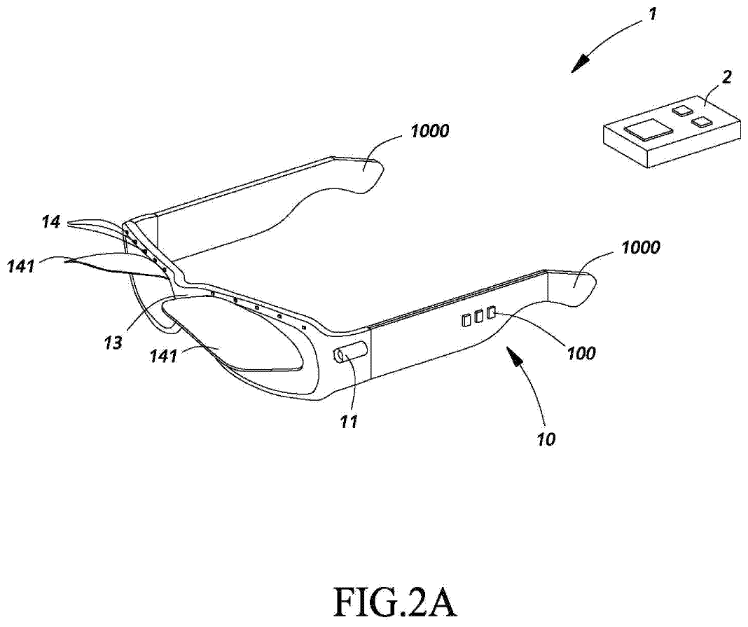

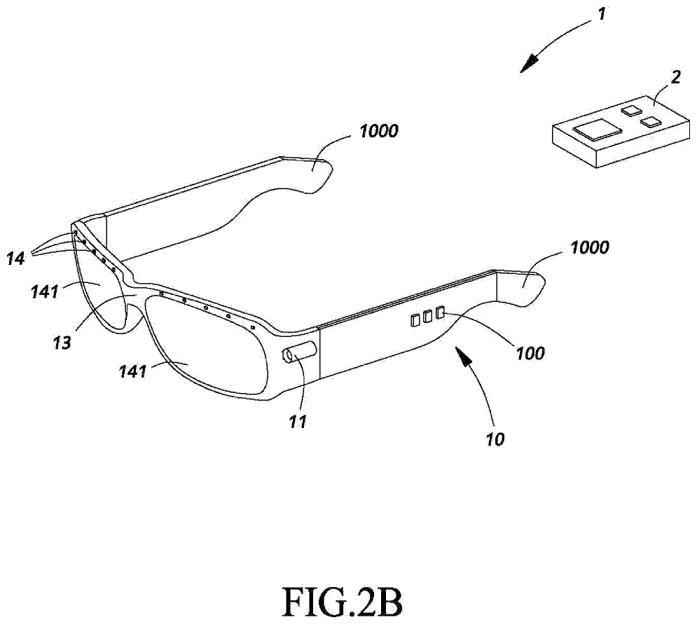

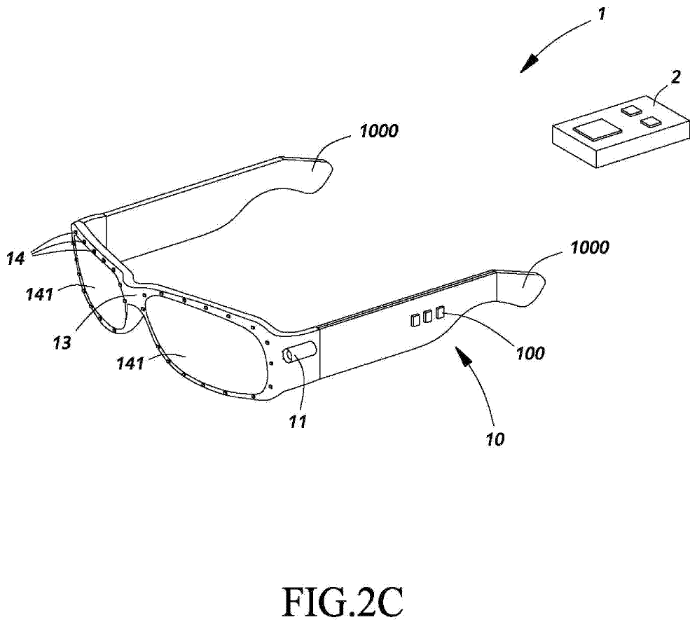

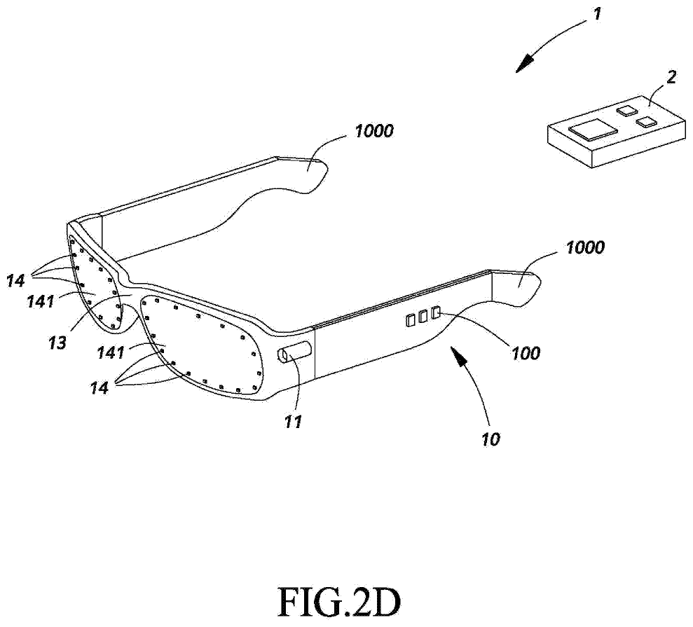

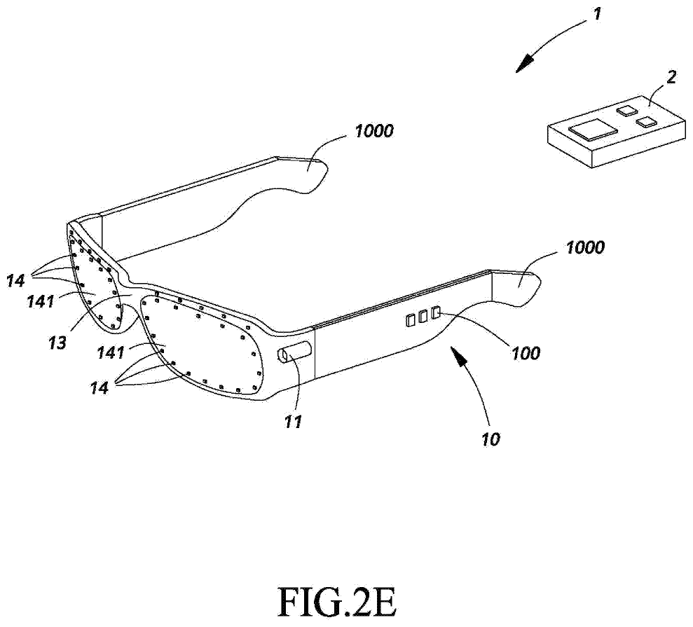

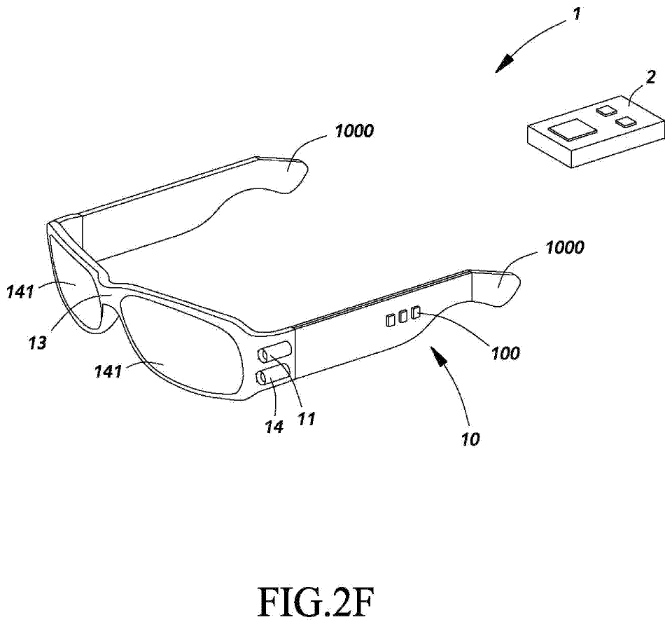

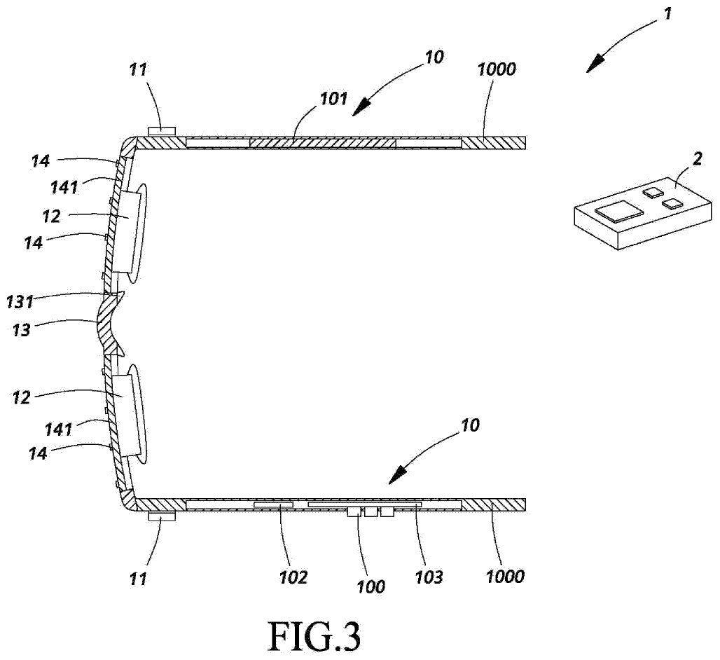

In order to facilitate the examiner to understand features, contents, advantages, and the effect that can be achieved in the present invention, the present invention is hereby detailed descripted by figures and embodiments as following. Figures in the text are only for illustration and auxiliary explanation, not necessarily for real proportion and accurate configuration of the present invention. Therefore, the proportion and configuration of the drawing should not confine the patent scope of the present invention in practical implementation. The preceding context should be claimed first. FIG. 1, FIG. 2A, FIG. 2B, FIG. 2C, FIG. 2D, FIG. 2E, FIG. 2F, and FIG. 3 refer to the three-dimensional breakdown drawing of the present invention, the three-dimensional assembly drawing of the present invention, the pictorial drawing of the present invention which the lenses are lift up, the pictorial drawing of the present invention which the light-emitting apparatuses are set in front of the frame, the pictorial drawing of the present invention which the light-emitting apparatuses are set around the frame, the diagrammatic drawing of the present invention which the light-emitting apparatuses are attached outside of the frame, and the assembly profile drawing of the present invention, respectively. In one preferred embodiment of the optical photographic glasses of the present invention, the optical photographic glasses includes a frame 1, at least one camera lens 11, two screen 12, at least one light-emitting apparatus 14, and at least one telecontroller 2.

The one aforementioned frame 1 is equipped with the temple 1000 on its both sides and lens 141 in the front of the frame 1. The mobile component 1141 is set between the lens 141 and the frame 1 to turn down the lens 141 (as shown in FIG. 2B) or life up the lens 141 (as shown in FIG. 2A). This is not to limit the present invention whose structure can be without the mobile component 1141, while the lens 141 are directly fixed to the frame 1, which are all considered the scope of the present invention. In addition, at least one side of the temple 1000 is equipped with the electronic device 10 containing a battery 101. The electronic device 10 at the end portion of the temple 1000 is set a connection with the switch 100, and the bridge 13 with two nose pads 131 below is set in front of the frame 1. Furthermore, for efficient image storage and transmission of the optical photographic glasses of the present invention, the electronic device 10 further includes at least one storage device 102, or at least one WI-FI wireless internet device 103, or at least one storage device 102 and at least one WI-FI wireless internet device 103.

At least one of the aforementioned camera lens 11 is provided on the bridge 13 and connected with the electronic device 10.

The two aforementioned screens 12 are located nearby the front frame 1 and connected with the electronic device 10 comprising the camera lens 11.

At least one of the foregoing light-emitting apparatus 14 is provided on the frame 1. In this embodiment, the light-emitting apparatus 14 is directly set on the bridge 13 which is in front of the frame 1 (as shown in FIG. 2A), but this is not to limit the scope of the present invention. It may also be directly provided in front of the frame 1 (as shown in FIG. 2C) or around the lens 141 (as shown in FIG. 2D) or around the frame 1 and lens 141 (as shown in FIG. 2E) or the light-emitting apparatus 14 is attached outside of the frame 1 (as shown in FIG. 2F). Light-emitting apparatuses 14 of the present invention are visible light-emitting diodes (LED) or invisible light-emitting diodes (LED) or light-emitting apparatuses 14 with equivalent function, which are considered the scope of the present invention.

At least one of the aforementioned telecontroller 2 is to remote control the present invention, which further provides at least one telecontroller 2 connected to the electronic device 10. In other words, the optical photographic glasses of the present invention not only can utilize the switch 100 of the electronic device 10 at the temple 1000 to turn on or turn off the electronic device 10 or the camera lens 11 or the light-emitting apparatus 14, but also press the telecontroller 2 to wirelessly turn on or turn off the electronic device 10 or the camera lens 11 or the light-emitting apparatus 14.

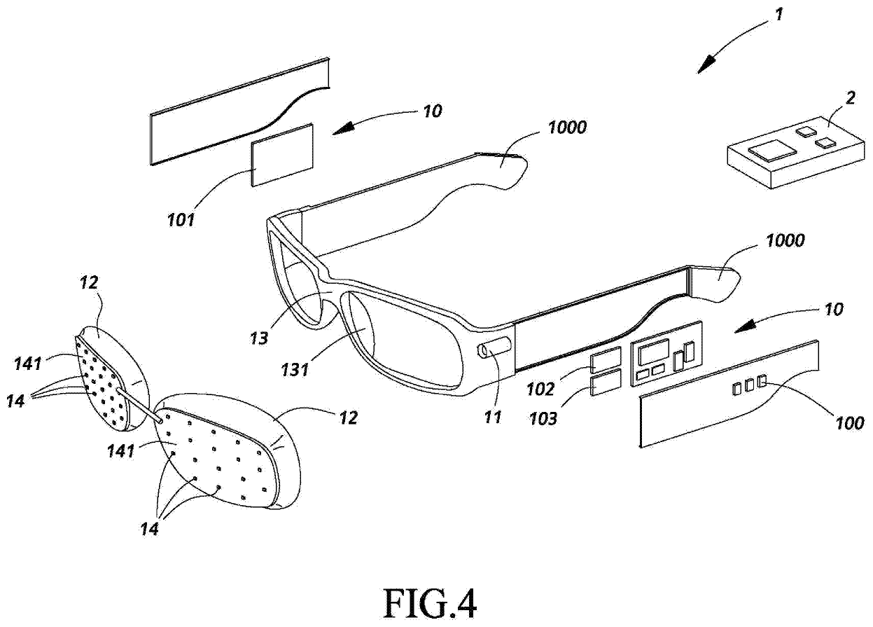

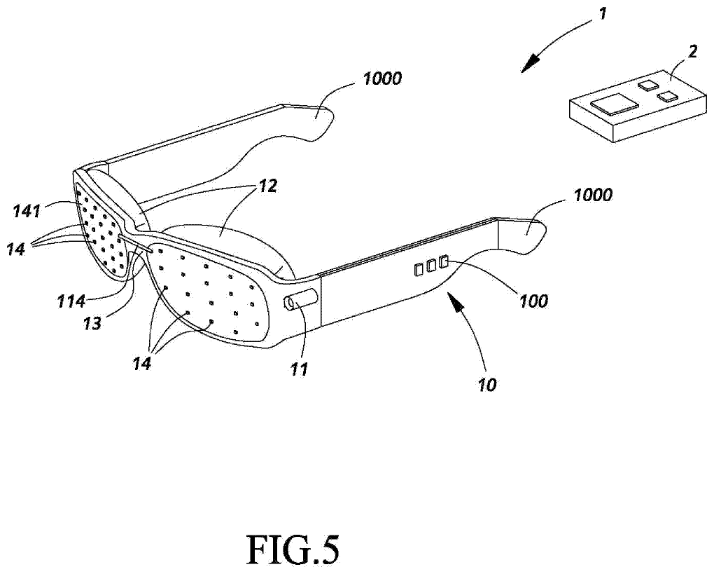

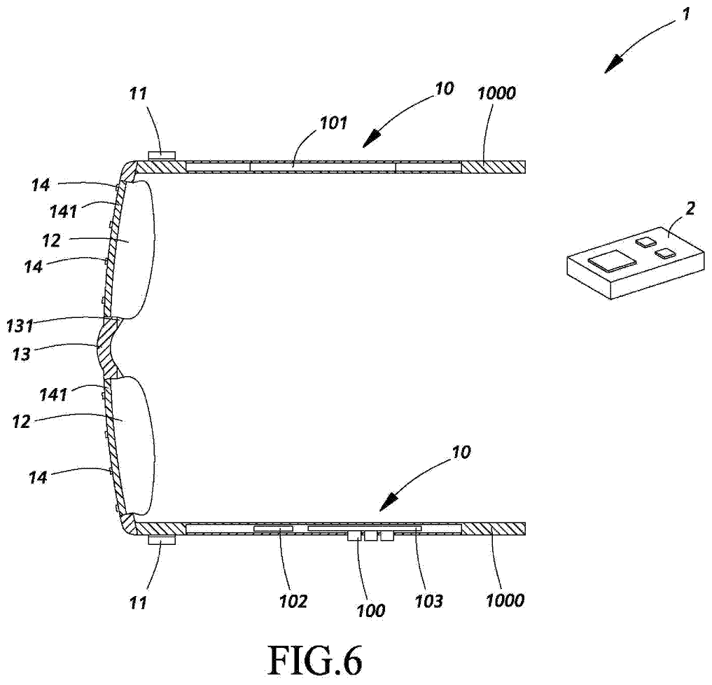

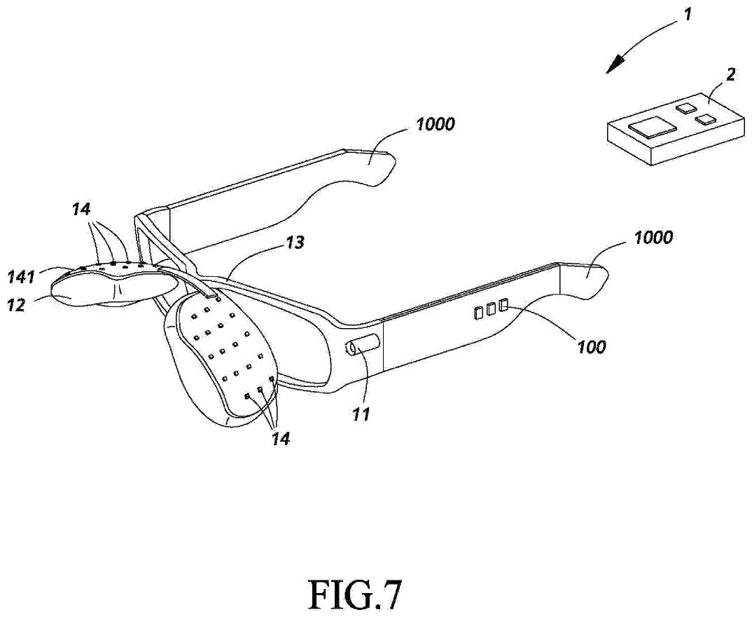

FIG. 4, FIG. 5, FIG. 6, and FIG. 7 refer to the three-dimensional breakdown drawing of another embodiment in the present invention, the three-dimensional assembly drawing of another embodiment in the present invention, the assembly profile drawing of another embodiment in the present invention, and the diagrammatic drawing of another embodiment in the present invention which the screen comprising light-emitting apparatuses are lift up, respectively. In one preferred embodiment of the optical photographic glasses of the present invention, the optical photographic glasses includes a frame 1, at least one camera lens 11, at least one screen 12, a lot of light-emitting apparatus 14, and at least one telecontroller 2.

The one aforementioned frame 1 is equipped with the temple 1000 on its both sides, the electronic device 10 comprising a switch 100 and the battery 101 at least one side of the temple 1000 of the frame 1, and the bridge 13 with two nose pads 131 in front of the frame 1. Furthermore, for efficient image storage and transmission of the optical photographic glasses of the present invention, the electronic device 10 further includes at least one storage device 102, or at least one WI-FI wireless internet device 103, or at least one storage device 102 and at least one WI-FI wireless internet device 103 which are connected to each other.

At least one of the aforementioned camera lens 11 is provided on the bridge 13 and connected with the electronic device 10.

At least one of the aforementioned screen 12 is set under the bridge 13 of the frame 1. The mobile component 114 is set between the screen 12 and the bridge 13 to lift up or turn down the screen 12, and the screen 12 is connected with the electronic device 10.

The aforementioned light-emitting apparatuses 14 are arranged directly in front of the screen 12. In this embodiment, the light-emitting apparatuses 14 are visible light-emitting diodes (LED) or invisible light-emitting diodes (LED), but this is not to limit the scope of the present invention. Light-emitting apparatuses may also be the other kinds of light-emitting apparatuses 14 of equivalent function, which are all considered the scope of the invention. In addition, the camera lens 11 of the present invention can take clear images regardless of day or night, and the user can directly observe the front images through the screen 12, so that it will not affect the sight even if the screen 12 is not lifted up.

At least one of the aforementioned telecontroller 2 is to remote control the present invention, which further provides at least one telecontroller 2 connected to the electronic device 10. In other words, the optical photographic glasses of the present invention not only can utilize the switch 100 of the electronic device 10 at the temple 1000 to turn on or turn off the electronic device 10 or the camera lens 11 or the light-emitting apparatus 14, but also press the telecontroller 2 to wirelessly turn on or turn off the electronic device 10 or the camera lens 11 or the light-emitting apparatus 14. In the present embodiment, while not using the screen 12 containing light-emitting apparatuses 14, the mobile component 1141 between the bridge 13 of the frame 1 plays a role as the axis to lift up the screen 12 (as shown in FIG. 7). While using the screen 12 again, the screen 12 comprising light-emitting apparatuses 14 can be turned down as shown in FIG. 5.

In this way, the pair of optical photographic glasses provides auxiliary light source by at least one light-emitting apparatus 14, and can directly store images of the camera lens 11 in the storage device 102 of the electronic device 10, or directly transmit images by video party through the WI-FI wireless internet device 103, or store images in the storage device 102 and transmit images to computers via the WI-FI wireless internet device 103. It's also according to the user's needs to lift up or turn down the lens 141 or screens 12, and using the telecontroller 2 as a wireless remote control. Regardless of during day or night, immediate image storage and transmission via the camera lens 11 can effectively enhance its ease of use, and result in correspondence of novelty and improvement with the user's needs, which shows the gain of the invention.

In conclusion, with regard to the breakthrough in the prior art, the present invention has indeed achieved the desired improvement, and the invention is not easy to plot for those who are not familiar with the art. Moreover, the present invention has not been disclosed prior to the application. The content of the present invention follows industrial applicability, novelty, and progressiveness, so that the present invention has significantly complied with the patentability requirements for patent application. Pursuant to the Patent Act, the applicant renders the patent application and solicits the Patent Authority for consent to the present application in order to encourage invention.

The aforementioned embodiments are merely to illustrate the technical concepts and characteristics of the present invention, which aim to make the skilled in the art to understand the invention and implement it on the ground of the content of the present invention. The embodiments can not confine the patent scope of the invention. Any changes and modification based on the disclosed concepts of the present invention should be covered in the scope of the present invention.

What is claimed is:

1. A pair of optical photographic glasses; the pair of optical photographic glasses includes:
one frame, which is equipped with temples on its both sides, lenses in the front of the frame, and an electronic device with a battery at least one side of the temple of the frame; the electronic device at the end portion of the temple connects with one switch and a bridge with two nose pads below is set in front of the frame;
at least one camera lens, which is provided on the bridge and connected with an electronic device;
two screens, which are located nearby the front of the frame and connected with the electronic device containing a camera lens;
at least one light-emitting apparatus, which is set in the frame.

2. The pair of optical photographic glasses to claim 1 wherein a mobile component is appended between the lens and the frame of the present invention and it can turn down or lift up the lens.

3. The pair of optical photographic glasses to claim 1 wherein the light-emitting apparatuses of the present invention are set in front of the frame, or on the bridge which is in front of the frame, or around the lens which is in front of the frame, or around the frame and lenses.

4. The pair of optical photographic glasses to claim 1 wherein the light-emitting apparatuses of the present invention are visible light emitting diodes or invisible light mitting diodes.

5. The pair of optical photographic glasses to claim 1 wherein the electronic device of the present invention has at least one storage device, or at least one WI-FI wireless internet device, or at least one storage device and at least one WI-FI wireless internet device.

6. The pair of optical photographic glasses to claim 1 wherein the present pair of optical photographic glasses further includes at least one telecontroller connected with the electronic device.

7. A pair of optical photographic glasses; the pair of glasses includes:
one frame, which is equipped with temples on its both sides, an electronic device with a switch and a battery at least one side of the temple, and a bridge with two nose pads in front of the frame;
at least one camera lens, which is provided on the bridge and connected with an electronic device;
at least one screen, which is set under the bridge of the frame. A mobile component is set between the screen and the frame to life up or turn down the screen which is connected with the electronic device;
a lot of light-emitting apparatuses which are set in front of the screen.

8. The pair of optical photographic glasses to claim 7 wherein the light-emitting apparatuses of the present invention are visible light emitting diodes or invisible light emitting diodes.

9. The pair of optical photographic glasses to claim 7 wherein the electronic device has at least one storage device, or at least one WI-FI wireless internet device, or at least one storage device and at least one WI-FI wireless internet device which are connected to each other.

10. The pair of optical photographic glasses to claim 7 wherein the present pair of optical photographic glasses further includes at least one telecontroller connected with the electronic device.
